(19) United States
(12) Patent Application Publication
(10) Pub. No.: US 2026/0304574 A1
(43) Pub. Date: Oct. 1, 2026

(54) METHOD FOR OPERATING A LIGHTING ARRANGEMENT AND A LIGHTING ARRANGEMENT

(71) Applicant: SIGNIFY HOLDING B.V., EINDHOVEN (NL)

(72) Inventors: PETER DEIXLER, ARLINGTON, MA (US); DZMITRY VIKTOROVICH ALIAKSEYEU, EINDHOVEN (NL)

(21) Appl. No.: 19/476,725

(22) PCT Filed: Apr. 10, 2024
(86) PCT No.: PCT/EP2024/059738

§ 371 Date: Oct. 20, 2025

Related U.S. Application Data
(60) Provisional application No. 63/460,362, filed on Apr. 19, 2023.

(30) Foreign Application Priority Data
May 2, 2023 (EP) 23170964.3

(51) Int. Cl. H05B 45/50; H05B 47/115; H05B 47/14; H05B 47/17; H05B 47/175

(52) U.S. Cl. CPC H05B 45/50; H05B 47/115; H05B 47/14; H05B 47/17; H05B 47/196

(57) ABSTRACT

A method of controlling a lighting arrangement (1) in a lighting environment (10) is provided. The lighting arrangement (10) comprises at least one light unit (110-140) having at least one luminaire (111), a primary lighting function and being arranged the lighting environment (10). A secondary lighting function for the at least one light unit (110-140) is determined based on technical specifications of the light unit (110-140), a degradation of the light unit (110-140) and/or information regarding the lighting environment (10). The lighting function of the light unit (110-140) is changed from the primary light function to the secondary light function.

### FIELD OF THE INVENTION

The present invention relates to a lighting arrangement as well as a method for operating a lighting arrangement.

### BACKGROUND OF THE INVENTION

A lighting arrangement having a plurality of light units, Blinds, electronically adjustable transparency of glass window or luminaires in order to provide lighting for a room or an environment are well known. Modern lighting units have LED lights and are typically able to communicate wirelessly with other lighting units or with a central control.

US 2017/0013698 A1 discloses a system for managing street lights. The position and status of the street lights are received and control signals for the street lights are generated based on this information.

### SUMMARY OF THE INVENTION

During the lifetime of the lighting units, the lights or other components of the lighting units may degrade and may thus not be able to perform their initial function.

It is therefore an object of the invention to provide a lighting arrangement as well as a method of operating a lighting arrangement which is able to efficiently use the available lighting units.

According to a first aspect, a method of controlling a lighting arrangement in a lighting environment is provided. The lighting arrangement comprises at least one light unit having at least one luminaire, a primary lighting function and being arranged in the lighting environment. A secondary lighting function for the at least one light unit is determined based on technical specifications of the at least one light unit, a degradation of the at least one light unit and/or information regarding the lighting environment by a secondary lighting function determination unit. The lighting function of the at least one light unit is changed from the primary light function to the secondary light function.

Hence, a light unit which has degraded can be re-used in another function instead of being thrown away. Thus the life time of a light unit can be extended by using it in a different function better suited with its degraded state.

The secondary lighting function for the at least one light unit can also determined based on user information of a user in the lighting environment. Hence, the secondary lighting function can be adapted to preferences or user requirements.

A mobile device or a computer device with an application running on the mobile device or the computer device can be coupled with the secondary lighting function determination unit. The secondary lighting function determination unit transmits the proposed secondary lighting function to the application running on the mobile device or the computer device for display and confirmation.

According to an example, changing the lighting function of the at least one light unit from the primary light function to the secondary light function includes adapting an operation of the at least one light unit, changing a position of the at least one light unit, changing components of the at least one light unit and/or changing a mechanical arrangement of components of the luminaire.

According to an example, a controller is provided and is used to control the operation of the at least one light unit according to the secondary lighting function.

According to an example, the controller is configured to monitor the operation of the at least one light unit, to detect or predict a degradation of its operation and to initiate the secondary lighting function determination unit to determine the secondary lighting function. In an example sensor data can be used to predict an imminent degradation before it becomes visible to the use. For instance, the capacitor value of an output capacitor in the LED driver may soon degrade to such a level that the LED light will suffer from temporal light effect issues (flicker). If this is predicted or detected the controller can notify the secondary lighting determination unit.

According to an example, the information regarding the lighting environment includes position information of the at least one light unit, and/or a layout of the lighting environment.

According to an example, the secondary function includes position information and/or operational information to implement the secondary lighting function.

According to an example, the secondary lighting function determination unit comprises a machine-learning engine configured to provide the secondary lighting function based on training data including technical specifications of the at least one light unit, a degradation of the at least one light unit, information regarding the lighting environment and/or user information.

According to a second aspect, a lighting arrangement in a lighting environment is provided. It comprises at least one light unit having at least one luminaire, a primary lighting function and being arranged in the lighting environment, a controller configured to control the operation of the at least one light unit according to the primary lighting function, and a secondary lighting function determination unit configured to determine a secondary lighting function for the at least one light unit based on technical specifications of the at least one light unit, a degradation of the at least one light unit and/or information regarding the lighting environment. The controller changes the lighting function of the at least one light unit from the primary light function to the secondary light function and to control the operation of the at least one light unit according to the secondary lighting function.

According to a further aspect, a secondary lighting function determination machine-learning engine is provided which determines a secondary lighting function for at least one light unit in a lighting environment based on training data including technical specifications of the at least one light unit, a degradation of the at least one light unit, information regarding the lighting environment and/or user information.

According to an aspect, training data for a secondary lighting function determination machine-learning engine configured to determine a secondary lighting function for at least one light unit in a lighting environment is provided. The training data includes technical specifications of the at least one light unit, a degradation of the at least one light unit, information regarding the lighting environment and/or user information.

According to a further aspect, a computer program product for controlling a light arrangement in an environment is provided. The computer program product comprises program code means for executing the method of controlling a light arrangement as described above.

According to a further aspect of the invention, a lighting arrangement is provided. The lighting arrangement comprises a plurality of light units in an environment. The light units may be able to wired and/or wirelessly communicate with each other and a controller. The technical specifications of the light units as well as possible degradation of these technical specifications of the light units are received by a determination unit. The determination unit can furthermore receive information regarding the environment and user information. Based on the received technical specification data, the degradation data, the environment data and/or user information, the determination unit can determine a secondary function of at least one of the lighting units if the lighting unit has degraded such that it cannot anymore fulfill its primary lighting function. Information regarding the environment may also include style changes in the environment e.g. if the user has remodeled the bed from colonial style to modern style (where our colonial luminaire no longer fits in). Apart from a degrading of the lighting function (or yellowing of the luminaire due to old age), also the usefulness of the lighting fixture may change and may not be desired anymore (wrong style; no elderly person living in the house any more).

Defects which can lead to a degradation of the light units may include aging of LEDs, aging of housing, color degradation, deformation of the lighting fixture (e.g. due to hailstones having hit a garden light degrading the appearance of the lighting fixture; someone damaged the luminaire).

Secondary functions for a replaced light unit can include anti-stumble light, ambient lighting, home security light (e.g. for mimicking presence in the absence of the user) etc.

Information or technical specification regarding the light unit may include the number of power cycles, total number of working hours, operational temperature, lightning surges, input voltage transitions, cold-start events etc.

Information regarding the environment of the light unit may include a layout of the environment, number of rooms, number of light units in the rooms, power supply layout.

User information may include the age of the user, medical condition, personal preferences, design style preferences.

The mobile device can include or be coupled to an augmented reality headset, a virtual reality headset headsets, augmented reality glasses, virtual reality glasses or a hologram generating device. These can be used to output or display information for the user. This information may also include the proposed secondary lighting function with additional information.

According to an example, the primary lighting function of the at least one light unit comprises a primary sensing function enabling a presence, a motion sensing or a context awareness sensing. The secondary lighting function can also be determined based on the operation and/or requirements of the primary sensing function. The light units may comprise a transceiver (or a dedicated receiver and a transmitter) which can be used for RF based sensing. The context awareness sensing can include e.g. activity detection (someone reading vs sleeping on the couch vs watching TV vs interacting with another person).

When determining a secondary lighting function, the requirements of the sensing function can be taken into account by the secondary lighting determination unit. If the light is according to the second lighting function to be moved to a different, second room (for a secondary lighting function such as anti-stumble lighting), this can however affect the sensing operation e.g. the fall detection of the RF sensing. Hence, the secondary lighting determination unit may determined that it is to leave the light in the first room (i.e. not to change its location) but repurpose it with a different function such as a wall washing decorative light.

In another example, when the secondary lighting determination unit determines a secondary lighting function by moving the light to a specific spot in the lighting environment with the primary motivation for improving the sensing performance can be possible. A new lighting function can be determined by the secondary lighting determination function for the second room given that the light needs to be there for sensing purposes.

In an example, the user can prompt the secondary lighting determination unit to determine a secondary lighting function for a lighting unit in the lighting environment. The reasons for such a user prompt can be that the user may no longer like the style of the luminaire, either because he nowadays no longer favors the style or the luminaire's style is after the user refurbished the room no longer fitting the new room style. Similarly, the composition of the household may change making certain lighting functions no longer required. For instance, an elderly person may have moved to an elder care home and the household consists now only of the much younger person. Similarly, a young person may move out, hence, eliminating the need to have an entertainment lighting fixture next to the computer.

During the determination of the secondary function, a life cycle assessment LCA can be performed and may be part of the determination method. During the determination of the secondary function, an energy efficiency degradation can also be considered. According to an example, a digital twin (to match the degradation and available functions) of the network device can be used to determine the secondary function.

According to an example, a reduction in energy efficiency can be an indication of a degradation of the device. Hence, the user can be notified and a secondary lighting function can be determined.

The invention can be advantageously used to train a machine learning engine for determining a secondary lighting function or for refurbishing a light unit in a light arrangement.

It shall be understood that the method of operating a lighting arrangement according to claim 1, the lighting arrangement according to claim 12, secondary light function determination machine-learning engine according to claim 13, training data according to claim 14 and the computer program of claim 15 have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows a schematic block diagram of a lighting arrangement, and

FIG. 2 shows a flow chart of a method of operating a lighting arrangement.

### DETAILED DESCRIPTION OF EMBODIMENTS

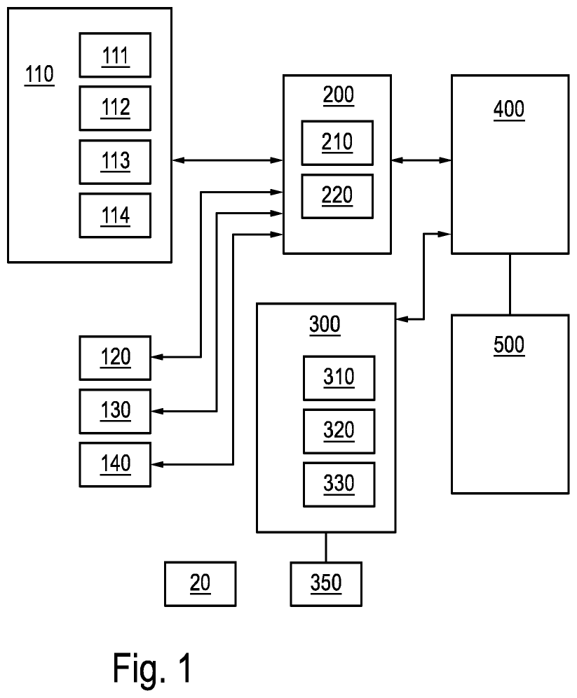

FIG. 1 shows a schematic block diagram of a lighting arrangement. The lighting arrangement 1 can be placed in an environment or a lighting environment 10. The lighting arrangement 1 comprises a plurality of light units 110, 120, 130, 140. The first light unit 110 can have a light or luminaire 111, a controller 112 and optionally a transceiver 113. The other light unit 120-140 can also comprise light or luminaire, a controller and optionally a transceiver.

The light arrangement 1 may also comprise a controller 200, preferably arranged in the environment 10 for controlling at least part of the lighting units 110-140. Optionally, the controller 200 may receive input from a mobile device or computing device 300 on which an application 310 is running. Optionally, by means of instructions received from the application 310, the controller 200 can control the function of the light units 110-140. The light units 110-140 can have the same function or can have different functions. At least one of the light units 110-140 can have a primary lighting function. The light arrangement 1 can comprise a secondary lighting function determination unit 400 or can be coupled to the determination unit 400 for example via a network like the internet. Alternatively, the determination unit 400 can be part of the controller 200 or can be part of anyone of the light units 110-140.

The secondary lighting function determination unit 400 can receive several input data, namely technical specification of the light units 110-140, degradation information of the light units 110-140, optionally environmental or arrangement information and/or user information to determine a secondary lighting function of a light unit if it is degraded. The technical specification may include the type of the light or luminaire or the design style of the luminaire or other electrical or electronic components like a driver or optical components or housing materials. The degradation information may include information on the light units 110-140 in particular if the light units are not able to meet the original specification anymore.

The controller 200 can comprise a control unit 210 and a transceiver 220. The transceiver 220 can also be implemented as a separate receiver and a separate transmitter.

The transceiver 220 can be used to communicate with the light units. Furthermore, the transceiver 220 can be used to communicate with the mobile device. Moreover, the transceiver can be used to communicate with the determination unit.

The environment information may include information on the environment 10 like the layout of the environment and the position of the respective light units as well as any other objects in the environment.

The user information may comprise information regarding the user or users 20 of the lighting arrangement 1. The information may include the age, preference or medical conditions of the user 20.

The secondary lighting function determination unit 400 uses this information to determine when one of the light units 110-140 are degraded in order to select a secondary lighting function for the light unit 110-140. In other words, if the light units 110-140 cannot fulfill its primary lighting function anymore, the determination unit 400 may select or propose a secondary lighting function which the light unit 110-140 can fulfill e.g. in the environment 10. In such a case, the light unit 110-140 which is to be replaced will not be operating anymore with its primary lighting function. Hence, a new corresponding light unit may be used to replace the degraded light unit which is to be replaced. The degraded light unit can be assigned to a secondary lighting function which can correspond to its degraded technical specification or degraded appearance and/or its design style.

Each light unit 110 can have a light or luminaire 111, a controller 112, optionally a transceiver 113 and a memory 114. The memory 114 can optionally be used to store meta data and process data of the light unit. This information can be forwarded to the determination unit 400. Alternatively, this information can also be stored in the controller 200 or in the determination unit 400. Alternatively, this information can also be stored in an online or cloud server 500.

Optionally, the user can initiate via the application 310 run on the mobile device that a light unit is to be replaced even if its function has not degraded.

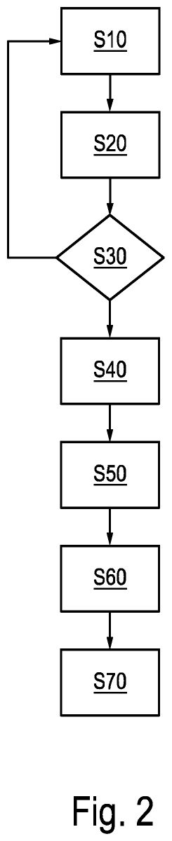

FIG. 2 shows a flow chart of a method of operating a lighting arrangement. In step S10, the lighting arrangement 1 controls the operation of the light units 110-140 and monitors the parameters of the light units 110-140. In step S20, a degradation of the light units 110-140 is determined, e.g. by one of the controllers 111, 200. If in step S30, the degradation is below a threshold, the flow continues to step S10. However, if the degradation is above a threshold, the flow continues to step S40. In step S40, the determining unit 400 determines a secondary function or use case of the light unit 110-140 based on technical specification of the light unit, degradation information, environment information and/or user information.

In step S50, the determined secondary function is output. In step S60, the function of the light unit 110-140 is changed from the primary lighting function to the secondary lighting function. The change of function may include a change in the parameters of the light unit and/or a change in the position or arrangement of the light unit in the environment. The change may also include a (partial) refurbishment of the light unit 110-140. For example, components of the light units 110-140 may be replaced or reused for other purposes.

As an example, one of the light units 110-140 may comprise a light/luminaire 111 which is aging and is not able for example to provide the required light intensity or lighting function according to its primary function. In such a case, the light unit will be replaced by a new light unit. With the proposed solution, it is however possible to reuse the light unit 110-140 which has been replaced. This is advantageous as it will avoid that the replaced light unit is thrown away and at the same time still fulfill a useful function for the user. With the help determining unit, a secondary lighting function is found for the replaced light unit. The user 20 can then install the replaced light unit in or at the secondary lighting function and/or lighting position. Thereafter, the new light unit can be reinstalled into the light arrangement 1. Accordingly, the replaced and reinstalled light unit can be reused in the lighting arrangement with a secondary lighting function.

The secondary lighting function can be different from the primary lighting function. Preferably, the secondary lighting function is of secondary purposes and for example not used for primary lighting function. A secondary purpose could be a stumbling light or the installation of the replaced light unit for decorative lighting or for entertainment lighting effects such as light flashes during games.

According to an example, a mobile device or computing device 300 on which an application 310 is running can be used as interface with the user 20. The application 310 can receive information from the determining unit 400 and can display a suggested secondary use of the replaced light unit 110-140.

The application 310 can also be used to display 330 that any of the light units 110-140 has degraded to such an extent that they need to be replaced. The determining unit 400 may in particular use user information to select a secondary function for the replaced lighting unit. As an example, the secondary lighting function can relate to a function that is not crucial and not safety relevant. Therefore, the replaced light unit can be downcycled and can only be tasked with incremental lighting enhancement of the room like adding a new nice-to-have lighting function to the user's environment. The new determining function selecting a secondary function or secondary use of a replaced light unit is advantageous for the user 20 as the replaced light unit does not need to be discarded and without any further expense for the user 20 the replaced light unit can be used in a downgraded fashion as an anti-stumble light, a wall washer, a cove-light etc. Once the user 20 has selected a secondary function for the replaced light unit, the replaced light unit with the new function must also be integrated into the lighting arrangement 1.

The user information can be important for the determining unit to select an appropriate secondary lighting function. For example, for an elderly person, an anti-stumble light can be a good solution as secondary lighting function. On the other hand, a younger person may prefer another secondary lighting function. For example, a young person with an elaborate entertainment center may want to use the replaced light unit as red-only dynamic ambient lighting wall washer for gaming purposes.

The technical specification and meta data of the lighting device may include all data collected during the lifetime of the light unit. This may include the number of power cycles, total number of working hours, operational temperature etc. The technical specification and metadata of the lighting device may include also sensor related data (e.g. degradation of a sensor due to aging, how often the sensor in the current position & role has actually provided useful information for the user e.g. the fall detection sensor is in a room which is hardly used by the elderly and hence not likely to experience a fall event). Furthermore, data regarding the electronics of the light unit apart from the specific light unit like a driver etc. may also be monitored and collected. In addition, environment information can be collected. Such environment information can be collected by external users such as smartphone cameras, etc. Based on the external sensors, a color rendering degradation, a state of optics, maximum minimum brightness and a broken LED can be detected. Based on external sensors, the performance of the sensor integrated in the lighting fixture can be detected. This information can be forwarded to the determining unit 400 to select an appropriate secondary lighting function for a light unit to be replaced.

The information provided for the determining unit 400 may include the type of the light unit or light source. Furthermore, by use of external sensors such as a camera or by manual input or by an input during the set up of the light arrangement, the set up of the light to be replaced can be detected or is determined beforehand. In other words, this may include information regarding the position of the light unit as well as the arrangement inside the light unit and the (non-lighting) sensors integrated in the light. Furthermore, the primary lighting function can also be determined. The primary lighting function can be for example a LED strip used for primary lighting of an environment like a room.

The determining unit 400 enables a user 20 to repurpose, reposition or partly recycle a lighting unit. The partly recycling may include removing defect parts of the lighting device and reuse still operating parts. For example, if the light unit 110 has an RF transceiver 130 and the RF transceiver is defect, the light unit for example having an LED strip can still be used as a stumble light without the necessity of being able to communicate via the RF transceiver.

The environmental information may also comprise information regarding possible secondary lighting functions. These secondary lighting functions can for example be determined or collected while setting up the lighting arrangement. In other words, during the set up of the lighting arrangement, the user 20 may be asked for any secondary lighting options which he would like to implement in the future.

The proposed determining function for secondary lighting functions is in particular advantageous as it will enable the user 20 to reuse any replaced lighting units. Thus, the user 20 may improve the lighting environment with the secondary function of the replaced light units. Furthermore, the replaced light units can be downgraded and recycled and can thus have a secondary life or secondary function.

The application 310 can be able to communicate with the determining unit 400 directly or via the controller 200. When it is determined that the function of a light unit has degraded below a preselected threshold, then the application 310 can initiate a communication with a user 20. It can inform the user 20 that one of the light units 110-140 or sensors needs to be replaced and it can propose a secondary lighting function for the light unit or sensing unit to be replaced. Accordingly, the application 310 is used to suggest adaptations of the primary use of the light unit which is to be replaced. This will allow a lifetime increase of the light unit 110-140 based on the secondary function. Accordingly, a light unit 110-140 can have a first lifetime based on a primary lighting function and a second lifetime based on a secondary lighting function.

This is advantageous as it will allow the user 20 to reduce its carbon and/or environmental footprint and to enjoy additional lighting functions without having to purchase additional light units.

Optionally, in order to determine information on the environment, the user 20 may be instructed by the application 310 to activate a camera 320 and/or LiDAR scanner of the mobile device and to scan the environment. The application 310 may in particular suggest specific areas which should be scanned more carefully by the camera 320 of the mobile device 300. This information can be used by the determining unit 400 to improve the determining process as it will have a greater understanding of the particularities of the environment.

When the replaced light unit 110-140 has been installed in its secondary position and the secondary lighting function has been activated, a central controller 200 or the controller 112 of the light unit 110 can control the light or luminaire 111 based on a secondary control function. The secondary control function may be adapted to the downgraded state of the replaced light unit. For example a degree of lighting dynamics may be limited and/or the sensing function may be limited (for instance to only perform movement detection (large movements) and not breathing detection). This is advantageous as the degradation for example of an LED driver capacitor or RF sensing radio can be taken into account.

The determining unit 400 may also enable severely degraded light units to be reused in a secondary function. The application 310 may be used to indicate to the user 20 that the light unit 110 is not able or should not be used in its original preliminary lighting function as a continued use may lead to a damage of the light unit. The user 20 can instruct the lighting arrangement via the application 310 to limit the function of one of the light units e.g. to avoid special modes which could further degrade the function of the light unit.

For example, by means of the application 310, the system may present the user 20 with the proposed secondary function of the light unit which is constructed based on different components of light units in the environment. The application 310 or the augmented reality AR goggles may visually display the obtainable light effect after the proposed hybrid downcycling. If extendable light devices like LED light strips are used, any still operational parts of the LED module can be used to extend the length of another light device of the same type. For example, while the default length of a light strip can be two meters, the LED driver may allow the length to be extended up to for example 5 meters. If one of the light units is degraded but the LED strips are still usable, they can be used and can be attached to an existing light strip thus extending the length of the light strip. On the other hand, if the LED driver is defect, it may be replaced by one of the LED drivers of a light unit to be replaced.

Optionally, the repurposed LED strip may remember some of its light settings and/or sensor settings and transfer the settings to the repurposed location. On the other hand, it is also possible that all settings are deleted and new settings are stored in the light unit.

According to an example, the application 310 or any other user interface of the system may communicate with the user 20 and demonstrate the position for the secondary function as well as any necessary steps to refurbish the light unit to be replaced to enable to function with the secondary lighting function. In particular, the location position for the new location opposition to enable the secondary lighting function may be displayed on the user interface or AR goggle. This may include information where the secondary lighting function and/or sensing function is to be obtained like at floor level, at high ceiling location. Furthermore, it is also possible that the user interface 330 displays information regarding the secondary lighting function and/or secondary sensing function. Such information may include whether the secondary lighting function has a critical or non-critical function at its expected time of failure. Based on this information, the user 20 may decide which secondary lighting function the light units to be replaced or components thereof should fulfill. The determining unit 400 may propose to use the light unit with secondary lighting for a new lighting task within the lighting environment.

According to an example, if several light units are present in the environment and one of the light units is defect, the system may suggest to use any of the functions already existing light units and replace the degraded light unit. This can for example make sense if several light units are present and some of the light units have a primary lighting function while others are arranged at locations where the lighting intensity is of lesser importance. The user 20 may decide based on the information from the determination unit that the secondary lighting function should be that of a decorative wall washing light and not as an emergency lighting function mounted on a high ceiling.

In a further example, discarded parts of the light units 110-140 can be added to a circular eco system from which it can be used by other users for updating their lighting objects. The determining unit 400 can be implemented as a recommender engine which tries to limit the carbon footprint when assessing whether to propose to the user 20 to discard the part of the light unit which is to be replaced or to provide it for other users.

According to a further example, the system may be coupled to a logistic service 500 which has information on pre-owned lighting parts that are available for a second hand market place. Such components may be ordered via the logistic services to implement the secondary lighting function with the to be replaced light unit. This is in particular advantageous as some of the components of the light units may need to be replaced.

Optionally, the augmented reality function may be used to assess the properties of the available pre-owned light units. This information may include the degradation state, remaining useful life, the carbon footprint for shipping the module to the user's location before deciding which lighting module to propose to the user 20 for the upgrade. The proposed options can be displayed in the augmented reality AR system 350 or on the user interface together with information regarding the respective sustainability of the secondary lighting function and the components required thereof. The user interface and/or the augmented reality interface may provide the user 20 with a choice between providing modifying a lighting task which is starting not to be able to fulfill the lighting function or provide the light unit to be replaced as a pre-owned light unit for a second life usage.

If multiple light modules are present in the same room or area, the system may upgrade just one of the lighting modules with a component from the second hand market place and merely reshuffle the rest of the light units in the lighting environment or lighting area. Optionally, the assigned lighting task can be changed.

The user interface or the augmented reality interface may be used to visualize how the hybrid object could be updated using additional parts from other lighting devices. For example, a free floor standing lamp providing up lighting may only be extended with a reading light arm to fulfill a new function or compensate for the degraded intensity of the light source.

In a further example, the user interface or the augmented reality may be used to display different tier carbon footprints for each of the proposed options. Accordingly, the carbon footprint may be important for the user 20 when selecting the respective secondary lighting function with the respective light units.

According to an example, the light units may be included into multipurpose objects like furniture, housing components etc. In a further example, the light units can be embodied as LED strip modules that in turn can be embodied in dry wall ceilings or dry wall room dividers. Thus, the light units can be dry wall embedded light units. Alternatively, the light units can also relate to lighting modules that are suspended from the ceiling. According to this example, the LED strips may be reused to form a new LED strip which can have a secondary lighting function.

In a further example, the light units can be integrated or attached to multifunctional building objects or multifunctional furniture objects. The object will have a lighting function which is the primary lighting function for example achieved by LED strips and a secondary non-lighting function for example a chair, etc.

The determining unit 400 can based on the provided information suggest a secondary lighting function as well as a secondary non-lighting function for such an object.

According to a further example, a user interface or an augmented reality headset can assist a seller to show its pre-owned light to an interested second hand buyer in the buyer's room when rendering the second hand buyer a mixed reality lighting effect consisting of a first lighting effect rendered by the physical lights which the interested buyer already has plus the second hand lighting effect rendered only virtually.

An augmented reproduction can be achieved where the physical light effect of the light unit to be re-proposed together with the virtual light effect of the second hand components can be combined to show the buyer how a new lighting arrangement could look like. Additionally, a second light effect virtually displaced by the augmented reality unit in the buyer's room may be modified from the physical light effect observed in the seller's room to reflect the changes proposed by the determinator unit which effects one of the light units. In other words, by means of the augmented reality, the second hand buyer can perceive how the light effect can be for example part of the preowned light units of the seller is upgraded with different components like a new diffuser plate. This can in particular be done before the second hand module is actually installed in the light unit to be refurbished. This can enable the second hand buyer to choose whether or not he wants to realize the displayed lighting effects. If this is the case, then the buyer can buy the proposed second hand components.

This is advantageous as the desired lighting effect can be achieved with second hand components, thus reducing the carbon footprint and also reduce the costs for the lighting arrangement.

According to an example, changing the lighting function of the at least one light unit from the primary light function to the secondary light function includes adapting an operation of the at least one light unit, changing a position of the at least one light unit, changing components of the at least one light unit and/or changing a mechanical arrangement of components of the luminaire. For example luminaires can be arranged in a modular fashion (like lego bricks) for different lighting purposes. Hence, these modules can be re-arranged from a first arrangement (old luminaire) to a second arrangement (new luminaire). Some of the components may also be bendable e.g. for reorienting the head of a reading lamp.

According to an example, a user can send a request to the secondary lighting determination unit 400 to determine a secondary lighting function for at least one lighting unit 110-140. The lighting function of the at least one light unit 110-140 can then be changed from the primary light function to the secondary light function.

In an example, the user can prompt the secondary lighting determination unit to determined a secondary lighting function for a specific lighting unit in the lighting environment. The reasons for such a user prompt can be that the user may no longer like the style of the luminaire, either because he nowadays no longer favors the style or the luminaire's style is after the user refurbished the room not longer fitting the new room style. Similarly, the composition of the household may change making certain lighting functions no longer required. For instance, an elderly person may have moved to an elder care home and the household consists now only of the much younger person. Similarly, a young person may move out, hence, eliminating the need to have an entertainment lighting fixture next to the computer.

According to an example, the primary lighting function of the at least one light unit 110-140 comprises a primary sensing function enabling a presence or motion sensing. The sensing function can be secondary function of the light units 110-140. The sensing operation can be performed e.g. by the transceiver 113 as described below in more detail. The secondary lighting function can also be determined based on the operation and/or requirements of the primary sensing function. Hence, the secondary lighting function determination unit 400 may also take the primary sensing function into account when determining a secondary lighting function. For instance, if the secondary lighting function includes to move the light to a different, second room (for a secondary lighting function such as anti-stumble lighting), this can however affect a fall detection of the RF sensing of the current lighting environment. Therefore, the secondary lighting function determination unit 400 may instead decide to leave the light in the first room but repurpose it there as a wall washing decorative light.

In another example, if the secondary lighting function includes to move the light to a specific spot in the house with the primary motivation for improving the sensing performance, then a new lighting function can be defined for the second room given that the light needs to be there for sensing purposes.

The lighting environment 10 can include lighting system which can comprise a plurality of lights unit 100-140 which each can act as network device. Thus, a network of network devices (in form of the lighting units) can be present. The network devices can be distributed in the lighting environment or the lighting area and are configured to communicate with each other based on RF signals (e.g. via their transceivers). At least one network device is configured to receive RF signals (via the transceiver) which have been transmitted by one other network device and have travelled through the sensing area. The receiving network device can output a sensing signal based on the received RF signal.

The network of network devices (lighting units) can also be understood as a sensing network comprising at least the network devices. Preferably, the network comprises more than three network devices, wherein the number of network devices in the network can be adapted based on the sensing area (lighting environment or lighting area). For example, a larger space may require more network devices.

The network of network devices (lighting units) can detect a status, a position and/or a posture of a person in the lighting environment or lighting area based on the signal strength of the plurality of detected sensing signals and/or based on channel state information derived from the plurality of detected sensing signals and the predetermined generated wireless sensing signal transmitted by a wireless transceiver in the network device. A status, position or posture of a person in the lighting environment or lighting area can be based on the signal strength of the plurality of detected sensing signals. Since a signal strength of the sensing signal depends on the amplitude of the wireless signal that directly or indirectly (via reflections/diffraction) reach the wireless receiver or transceiver, the signal strength is indicative of the different paths the wireless signal can travel from the wireless transmitter to the wireless receiver. Since these paths are highly dependent on the environment between the transmitter and the receiver, they are thus also dependent on the position of a person in the environment. The signal strength can be indicative of these positions or motions. Moreover, since the signal strength of the plurality of detected signals is utilized and as the sensing signals are detected by the network devices arranged at different locations, more precise information on the environment of the network devices can be obtained as a plurality of different wireless transmission paths in the sensing area is present.

A position and/or a motion of at least one person in the lighting environment or lighting area can be detected based on the channel state information derived from the plurality of detected sensing signals and the predetermined generated wireless signal emitted by the transmitter. The channel state information can be indicative of the properties of the path that the wireless signal has taken from the wireless transmitter in the first network device to the wireless receiver in a second network device and thus describes how the wireless signal has propagated from the transmitter to the receiver. Accordingly, the channel state information can also be indicative of an interaction of the wireless signals with a person along the propagation path. Thus, the channel state information can provide very accurate information on the environment of the network with which the wireless signal is interacting. Since the predetermined generated wireless signal of the transmitter is known and due to the network characteristics of the network, the channel state information can be derived from the sensing signals.

According to an example, a motion detector can be implemented as a network of network devices. Such network devices can be regarded as any device adapted to form a network with other network devices. In particular, a network device (lighting unit) comprises a network device communicator that is adapted to receive and transmit wired or wireless signals, for instance, radiofrequency signals, infrared signals, transmit and receive audio signals for audio sensing purposes, electrical signals, etc.

The network between the network devices can then be formed through a communication between the network devices following a known network communication protocol like WiFi, ZigBee, Thread, Bluetooth, etc. Preferably, the network devices refer to smart devices, i.e. devices comprising a communication unit for receiving and transmitting network communication signals but which otherwise fulfil the function of a corresponding conventional device. In particular, such a smart device can be a smart home or office device, in which case the corresponding conventional function would be that of a conventional home or office device. Preferably, the conventional function refers to a lighting function and the network devices refer to network lighting devices that are further adapted to comprise a wireless transmitter and/or a wireless receiver. Optionally the network devices can also comprise a sound generator and/or a sound detector for audio sensing. However, the network devices can also refer, for instance, to smart plugs, smart switches, etc.

The system can be part of the network, for instance, can be part of one or more of the network devices. In particular, the system can be provided as hard-and/or software as part of one of the network devices or distributed over a plurality of the network devices that are in communication with each other to form the system. However, the system can also be provided as a standalone system, for instance, in a device that is not part of the network of network devices but is directly or indirectly in communication with at least one of the network devices, for instance, to control the network devices. For instance, the system can be provided as part of a handheld computational device like a smartphone, a tablet computer, a laptop etc. However, the system can also be located in a cloud formed by one or more servers, wherein in this case the system might communicate with the network, in particular, the network devices, via one or more devices that are connected to the cloud like a router.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

A computer program may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

1. Method of controlling a lighting arrangement in a lighting environment, wherein the lighting arrangement comprises at least one light unit having at least one luminaire, a primary lighting function and being arranged in the lighting environment, comprising the steps of:
determining or predicting a degradation of operation of the at least one light unit such that the at least one light united does not meet a technical specification requirement of the primary lighting function;
determining a secondary lighting function for the at least one light unit based on technical specifications of the at least one light unit, a degradation of the at least one light unit and/or information regarding the lighting environment by a secondary lighting function determination unit, wherein the at least one light unit meets a technical specification requirement of the secondary lighting function, and
changing the lighting function of the at least one light unit from the primary light function to the secondary light function, wherein changing the lighting function of the at least one light unit from the primary light function to the secondary light function comprises adapting an operation of the at least one light unit.

2. Method of controlling the lighting arrangement according to claim 1, wherein
the secondary lighting function for the at least one light unit is also determined based on user information of a user in the lighting environment.

3. Method of controlling the lighting arrangement according to claim 1, wherein
a mobile device or a computer device with an application running on the mobile device or the computer device are coupled with the secondary lighting function determination unit,
wherein the secondary lighting function determination unit transmits the proposed secondary lighting function to the application running on the mobile device or the computer device for display and confirmation.

4. (canceled)

5. Method of controlling the lighting arrangement according to claim 1, wherein
a controller is configured to control the operation of the at least one light unit according to the secondary lighting function.

6. Method of controlling the lighting arrangement according to claim 1, wherein
the information regarding the lighting environment includes position information of the at least one light unit and/or a layout of the lighting environment.

7. Method of controlling the lighting arrangement according to claim 1, wherein
the secondary function includes position information, orientation information and/or operational information to implement the secondary lighting function.

8. Method of controlling the lighting arrangement according to claim 1, wherein
the secondary lighting function determination unit comprises a machine-learning engine configured to provide the secondary lighting function based on training data including technical specifications of the at least one light unit, a degradation of the at least one light unit, information regarding the lighting environment and/or user information.

9. Method of controlling the lighting arrangement according to claim 1, wherein
the primary lighting function of the at least one light unit comprises a primary sensing function enabling a presence or motion sensing or context-awareness sensing,
wherein the secondary lighting function is also determined based on the operation and/or requirements of the primary sensing function.

10. Method of controlling the lighting arrangement according to claim 1, comprising the steps:
sending a request by a user to the secondary lighting determination unit to determine a secondary lighting function for at least one lighting unit,
determining a secondary lighting function for the at least one light unit according to the request of the user, and
changing the lighting function of the at least one light unit from the primary light function to the secondary light function.

11. Lighting arrangement in a lighting environment, comprising:
at least one light unit having at least one luminaire, a primary lighting function and being arranged in the lighting environment,
a controller configured to control the operation of the at least one light unit according to the primary lighting function and monitor the operation of the at least one light unit, to detect or predict a degradation of its operation, such that the at least one light unit does not meet a technical specification requirement of the primary lighting function, and
a secondary lighting function determination unit configured to determine a secondary lighting function for the at least one light unit based on technical specifications of the at least one light unit, a degradation of the at least one light unit and/or information regarding the lighting environment, wherein the at least one light unit meets a technical specification requirement of the secondary lighting function,
wherein the controller is configured to change the lighting function of the at least one light unit from the primary light function to the secondary light function, wherein changing the lighting function of the at least one light unit from the primary light function to the secondary light function comprises adapting an operation of the at least one light unit, and to control the operation of the at least one light unit according to the secondary lighting function.

12. Secondary lighting function determination machine-learning engine configured to determine a secondary lighting function for at least one light unit in a lighting environment based on training data including technical specifications of the at least one light unit, a degradation of the at least one light unit, information regarding the lighting environment and/or user information.

13. Training data for a secondary lighting function determination machine-learning engine configured to determine a secondary lighting function for at least one light unit in a lighting environment, comprising:
technical specifications of the at least one light unit,
a degradation of the at least one light unit,
information regarding the lighting environment and/or
user information.

14. Computer program product for controlling a light arrangement in an environment, wherein the computer program product comprises program code means for executing the method of controlling a light arrangement according to claim 1.
